(19) United States
(12) Patent Application Publication
(10) Pub. No.: US 2016/0341598 A1
(43) Pub. Date: Nov. 24, 2016

(54) SYSTEM AND METHOD FOR ESTIMATING POWER SPECTRAL DENSITY OF A SIGNAL DERIVED FROM A KNOWN NOISE SOURCE

(71) Applicant: VIBRATION RESEARCH CORPORATION, Jenison, MI (US)

(72) Inventor: Philip Dean Van Baren, Wyoming, MI (US)

(21) Appl. No.: 15/150,950

(22) Filed: May 10, 2016

Related U.S. Application Data
(60) Provisional application No. 62/163,006, filed on May 18, 2015.

(51) Int. Cl. G01H 17/00; G01M 7/02

(52) U.S. Cl. CPC G01H 17/00; G01M 7/025

(57) ABSTRACT

An apparatus, system and method for estimating power spectral density (PSD). A processing apparatus and a test system are operatively coupled where a random signal generator produces a source signal comprising known statistical properties, and a first converter converts the source signal to a power spectral density (PSD) representation. The test system receives the source signal and produce an output signal, where a second converter converts the output signal to a second PSD representation, and an estimator estimates a magnitude-squared frequency response function (MSFRF) of the output signal and source signal. A weighting module may weight an estimation error factor based on at least one of a quality of the estimate and a user preference, and a removal module, removes a portion of the estimation error from the output signal PSD.

### CROSS REFERENCE TO RELATED APPLICATIONS

This application claims priority from co-pending U.S. provisional application No. 62/163,006, filed May 18, 2015, the content of which is herein incorporated by reference in its entirety.

### FIELD OF THE DISCLOSURE

The present disclosure relates generally to mechanical vibration systems and more specifically to accurately estimating the Power Spectral Density of random vibrations.

### BACKGROUND

Mechanical vibration is a normal part of the environment for most products, whether they are vehicles, which experience vibration whenever they are moving, cell phones, which are frequently bumped or dropped, or household items, which must be shipped from the factory to the store, and then on to the home. Because of this, most products incorporate some level of vibration testing in their design and validation. A common method of vibration testing uses a randomly varying motion, typically measured as acceleration, with a prescribed power spectral density (PSD).

Inherent in performing a test of this type is the requirement to estimate the PSD of the actual vibration applied to the product under test, in order to verify that the vibration levels used in the test are at prescribed levels. This estimation is customarily performed by taking a segment of the waveform, applying a window function to the segment, converting that segment from the time domain to the frequency domain using a Fourier Transform, and scaling the result to give a calibrated estimate of the signal's PSD. Due to the random nature of the waveform in the time domain, each frequency component of the estimated PSD resulting from this conversion to the frequency domain also has random variations in level, typically expressed as a chi-squared random variable with 2 degrees of freedom.

To reduce the variance of the PSD estimate, the waveform is typically divided into a set of equally sized segments, where a PSD estimate of each segment is computed and averaged together. When the waveform is stationary, the statistical properties of the waveform are the same for each waveform segment included in the average calculation, and therefore the average of the estimates will give an improved estimate of the actual PSD of the waveform. The resulting estimate will have the characteristics of a chi-squared random variable with 2*F degrees of freedom, where F is the number of independent segments of data included in the average. For such configurations the resulting characteristics are (1) that when only a small amount of data is available, the variance of the estimate is large, and (2) that the variance of the PSD estimate will decrease with the amount of data available to include in the average.

These configurations may be deficient in that there is an inherent trade-off between the accuracy of the estimate and the amount of data required to compute the estimate. In many cases, achieving the desired accuracy may require measuring a long segment (e.g., a minute or more of data) before sufficiently accurate estimates may be calculated. This has implications both in how the data are presented during the period of accumulating sufficient information, and also in how potential non-stationary behavior is hidden by the averaging. If the intermediate PSD estimates are presented to the operator prior to accumulating enough data to compute a sufficiently accurate PSD estimate, the resulting estimates will inevitably have more than the desired amount of variance, which will result in some measurements laying outside of the prescribed tolerance interval.

To address this concern, one commonly used technique is to accumulate data at a lower, non-damaging, amplitude level and then using those estimates as an initial estimate of the PSD at the full test level. This technique allows the presentation of data to have the apparent accuracy of the low level readings present at the beginning of the full level waveform, before sufficient data has been measured at full level to support that amount of accuracy. As a result, it can hide the non-stationary behavior inherent in amplitude transitions. When a device under test has a large resonance, the frequency at which that resonance occurs will typically shift with the change in vibration level. When the low level measurements are included in the full level PSD estimates, the resulting averaging will hide the true nature of the resonance, and the data presented to the operator will appear to be as flat as the data accumulated at low amplitude levels even while the true PSD at full level deviates considerably from that projected estimate.

While such techniques provide certain improvements in the measurement, they are excessively inefficient. Technologies are needed that are capable of achieving an accurate estimate of the PSD, without requiring averaging of a large data set.

### SUMMARY

Accordingly, various embodiments are disclosed for utilizing a noise source with known statistics as the basis for producing a vibration. When the resulting vibration is correlated with the noise source, the additional knowledge about the statistics of the noise source may be transferred to the waveform measurements and used to improve the accuracy of the estimated PSD and significantly reduce the amount of data required to achieve a given accuracy in the estimate. This allows for presenting both an accurate measurement in terms of low variance, and in terms of presenting only measurements made at a vibration level. The result is a faster measurement which allows for quickly quantifying the signal and revealing the non-stationary behavior inherent in changing amplitudes.

In some illustrative embodiments, a system is disclosed for estimating power spectral density (PSD), comprising a processing apparatus, that may include a random signal generator for producing a source signal comprising known statistical properties, and a first converter configured to convert the source signal to a power spectral density (PSD) representation; and a test system, operatively coupled to the processing apparatus, the test system configured to receive the source signal and produce an output signal, wherein the processing apparatus further comprises a second converter configured to convert the output signal to a second PSD representation, an estimator configured to estimate a magnitude-squared frequency response function (MSFRF) of output signal and source signal, a weighting module, configured to weight an estimation error factor based on at least one of a quality of the estimate and a user preference, and a removal module, to remove a portion of the estimation error from the output signal PSD.

In some illustrative embodiments, a processor-based method is disclosed for estimating a magnitude-square frequency response function, comprising the steps of estimating, via a first estimator, a magnitude-squared coherence estimate; compensating, via a first bias correction, the magnitude-squared coherence estimate for bias; limiting, via a limiter, the bias-corrected magnitude-squared coherence (MSC) estimate to values, between 0 and 1; estimating, via a second estimator, a magnitude-squared transmissibility function; compensating, via a second bias correction, the magnitude-squared transmissibility function for bias; and multiplying, via a multiplication operator, the bias-corrected MSC estimate with the bias-corrected magnitude-squared transmissibility calculation, for providing an improved H₁ MSFRF.

### BRIEF DESCRIPTION OF THE FIGURES

The present disclosure will become more fully understood from the detailed description given herein below and the accompanying drawings which are given by way of illustration only, and which thus do not limit the present disclosure, and wherein:

FIG. 1 shows a block diagram of a system under an illustrative embodiment for estimating the power spectral density of a system output signal where the system input signal is generated by a noise source with known statistics;

FIG. 2 shows an illustrative embodiment of a magnitude-squared frequency response function estimator using a transmissibility calculation;

FIG. 3 shows an illustrative embodiment of the magnitude-squared frequency response function estimator using an H₁ transfer function estimate;

FIG. 4 shows an illustrative embodiment of a magnitude-squared frequency response function estimator using a modification of the H₁ transfer function estimate which has been corrected for bias; and

FIG. 5 shows simulated waveforms of PSD traces under illustrative embodiments, where conventional PSD estimator traces are compared with the PSD estimator traces produced under any of the illustrative embodiments in FIGS. 1-4.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

A method of measuring the Power Spectral Density (PSD) of a random waveform is described. This method has the unique characteristic of using the additional information available when the random waveform is correlated with a noise source with precisely known statistics, to provide a more precise estimate of the PSD.

The apparatus, system and methods include estimating the PSD of both the input and output of an arbitrary system, using identical calculations on both signals. Since the exact statistics of the noise source are well known, the difference between the known statistics and the estimated PSD of the noise source will be a measure of the estimation error of the PSD estimate of the noise source. In addition, the transfer function of the system through which the noise source propagates may be estimated. That estimated transfer function may then be used to project the known estimation error of the PSD estimate of the source signal to provide the estimation error of the PSD estimate of the output signal. The output signal estimation error may be subtracted off from the traditional PSD estimate to provide a more precise estimate of the signal PSD.

Generally speaking, and in the simplest case (i.e., without treating overlapping, windowing, etc. of PSD) and assuming Gaussian input data, a PSD estimate at a single frequency bin f (without loss of generality) may be determined from

$$PSD ( f ) = \frac{1}{2 F} ( {X}_{1 , R}^{2} + {X}_{1 , I}^{2} + {X}_{2 , R}^{2} + {X}_{2 , I}^{2} + ⋯ + {X}_{F , R}^{2} + {X}_{F , I}^{2} ) ,$$

where X_{q,R/I}² refers to the power contribution from the real or imaginary part of the qth frame, and where all the terms are independent and each term is the square of a standard normal random variable. In light this, the PSD estimate may be also determined from

$$PSD ( f ) = \frac{1}{2 F} ( {𝒳}_{2 F}^{2} ) ,$$

and the variance of the PSD at frequency bin f may be determined from

$$Var [ PSD ( f ) ] = \frac{2}{{( 2 F )}^{2}} Var ( {𝒳}_{2 F}^{2} ) = \frac{1}{4 {F}^{2}} 4 F = \frac{1}{{F}^{′}}$$

employing the variance property concerning a constant factor and the property that the variance of a chi-square distribution equals twice the number of degrees of freedom involved. Although a simple example, this demonstrates the inherent property of PSD averaging in general that variance is inversely proportional to the number of frames involved in the averaging. Consequently, during the early stages of a test when not many frames of data have been acquired and transformed, the PSD is expected to have and should exhibit high variance. In other words, during the early stages the PSD display is expected to look, and should look, jagged.

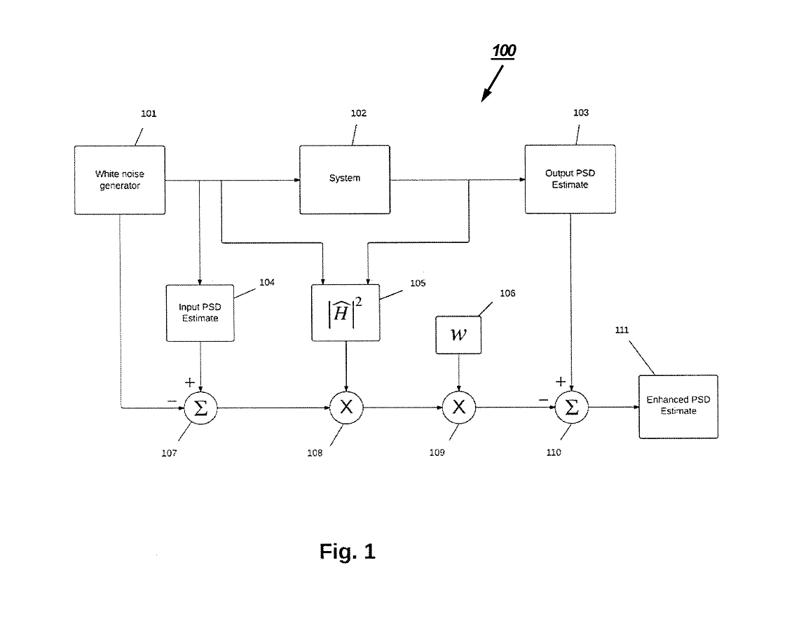

FIG. 1 details a block diagram of a system 100 under an illustrative embodiment for estimating a power spectral density of a system's output signal when the system's input signal is provided by a noise source 101 with known statistics. In an illustrative embodiment, noise source 101 may comprise a white noise generator for producing a known Power Spectral Density (PSD). This signal may be input and passed through a test system 102 to become the output signal. In some illustrative embodiments, test system 102 may include an object undergoing vibration testing (e.g., motor, blade, electronic device, etc.) that is coupled or placed on a vibration apparatus (e.g., shaker, vibrator, etc.), and may include processor(s), sensors, transducers and/or communication circuitry for communicating with other portions of system 100.

In addition to test system 102, output of noise source 101 may be provided to magnitude-squared frequency-response function (MSFRF) estimator 105 and PSD Estimator 104, where the original noise signal from source 101 may be subtracted in 107 as shown in FIG. 1. PSD Estimators may be configured at both the input 104 and output 103 signals, using identical or similar calculations. Since the exact PSD of the input may be known, the estimation error of the input PSD Estimator (e.g., 103, 104) can be directly computed by taking the difference between the known PSD and the estimated PSD 107.

When input PSD Estimator 104 and the output PSD Estimator 103 are using identical calculations on correlated data, then the estimate error of the output PSD Estimator is also correlated with the estimate error of input PSD Estimator 104. By also estimating the magnitude-squared frequency-response function (MSFRF) 105, the known estimation error of the input PSD Estimator may be transformed through multiplication 108 into a measure of the estimation error of the output PSD Estimator. This estimation error may then be removed 110 from the output PSD Estimator, providing an Enhanced PSD Estimate 111 with improved accuracy over conventional configurations.

In some illustrative embodiments, a weighting function 106, which may be configured with weighting values from 0 to 1, may also be applied via multiplier 109 to the estimation error to adjust how much of the correction is to be subtracted from the estimate. This weighting function may be set to a low value to reduce or eliminate the correction when the input and output signals show a low amount of correlation. It may also be used as a time-varying correction, to transition smoothly over time from the Enhanced PSD Estimate to the standard PSD Estimate, placing more weight on the Enhanced PSD Estimate when the standard PSD Estimate has a high level of variance, and then shifting the weight over to the standard PSD Estimate as the variance of that estimate is reduced by means of increased averaging. It may also be used as a weighting factor between the two estimates, to allow for presenting accurate measurements sooner, and with less averaging required than the standard estimator.

In some illustrative embodiments, system 100 may be embodied as a computing device (e.g., PC, laptop, workstation, etc.) that performs the functions described in blocks 101 and 103-111 utilizing tangibly-embodied software and/or encoded hardware modules while being coupled to test system 102. In other illustrative embodiments various computing device peripherals (e.g., one or more frequency analyzers, digital signals processors, A/D converters, etc.) may be operatively coupled to a computing device and/or test system 102. In still further illustrative embodiments, system 100 may be integrated into a single apparatus that performs all the functions described herein.

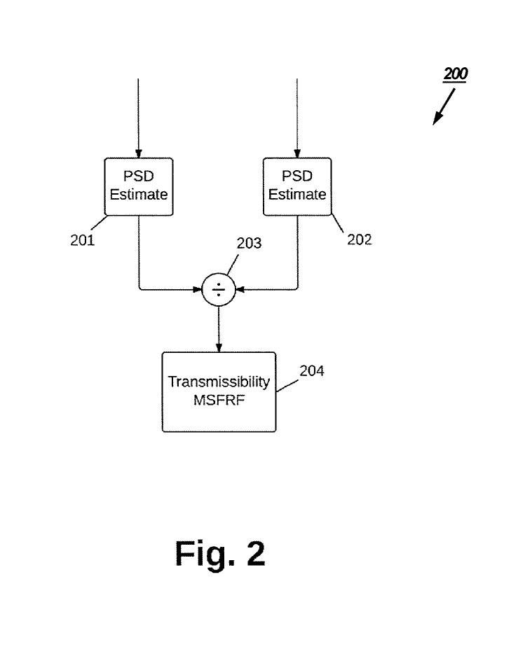

One aspect of providing an enhanced PSD estimate (e.g., 111) relates to the measurement and application of the MSFRF estimator 105. While the MSRF estimator may be configured in a variety of ways, FIG. 2 provides an illustrative embodiment of an MSFRF 200 where a response is computed using Transmissibility calculation. In this example, both the PSD of the input signal 201 (cf., 104 of FIG. 1) and the PSD of the output signal 202 (cf., 103 of FIG. 1) are estimated. Here, the PSD of the output signal is divided by the PSD of the input signal using a frequency-by-frequency division operator 203, resulting in the PSD ratio MSFRF 204.

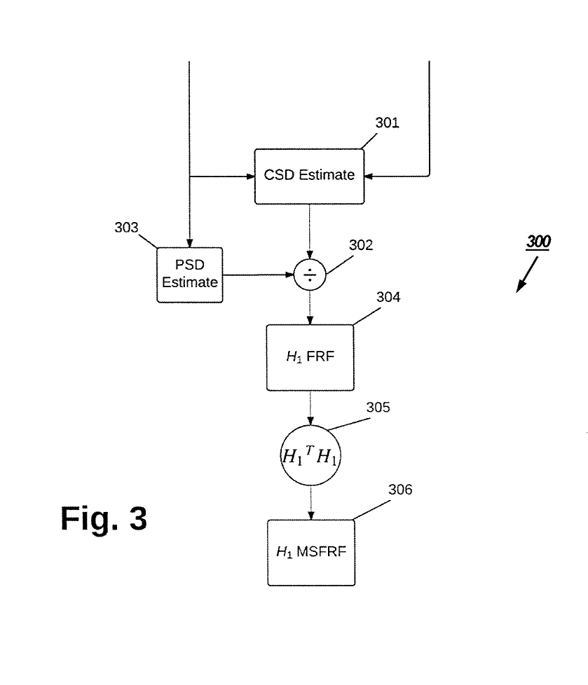

FIG. 3 details another illustrative embodiment 300 of a MSFRF estimator 105, where the response is computed using a H₁ frequency response function (FRF) estimation algorithm, which may generally expressed as a cross-spectral density (CSD) of the input and output as a quotient of an auto spectral density of the input. The CSD 301 between the input signal and output signal and the PSD 303 of the input signal may both be estimated, and the CSD between the input signal and output signal may be divided by the PSD of the input signal by means of a frequency-by-frequency division operator 302, resulting in the H₁ FRF 304. The magnitude-squared function of the H₁ FRF may produce the MSFRF 306.

It should be understood by those skilled in the art that there are many other embodiments of the MSFRF estimator 105 are contemplated in the present disclosure for achieving similar results, including, but not limited to, utilizing transfer function estimation algorithms H₂, Hᵥ and Hₛ. However, the H₁ FRF estimation method may be particularly advantageous, as the input readings are noise free while the output readings contain noise.

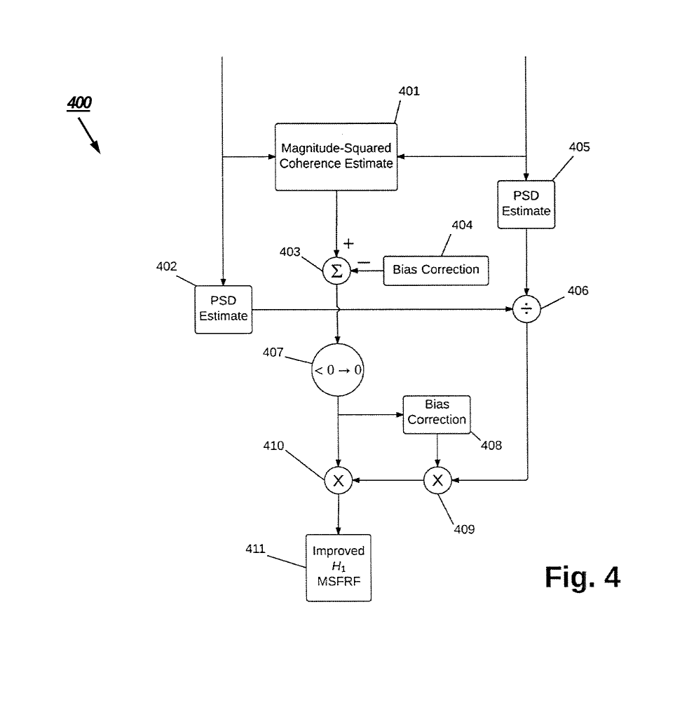

FIG. 4 shows an illustrative embodiment for further improved MSRF processing. In this example, the H₁ based MSFRF is biased when either the number of measurements averaged together is low, or the signals are poorly correlated. To improve upon this, an illustrative embodiment of a MSFRF system 400 is provided, where an MSFRF estimator is configured as a modification of a magnitude-square of the H₁ FRF estimator, along with one or more correction factors applied to produce an Enhanced PSD Estimate with reduced bias (111). In this example, the H₁ MSFRF estimator may be equal to the magnitude-squared coherence (MSC) calculation multiplied by the magnitude-squared transmissibility calculation.

To further enhance this estimator, the estimator may be separated into a plurality of components. First the MSC between the input signal and output signal is estimated in 401. The MSC may be adjusted in order to decrease its bias utilizing a bias correction factor 404, which may be a function of the MSC estimate and the number of data points included in the average calculation. The bias correction may be subtracted from the MSC using a frequency-by-frequency addition operator 403. All negative values of the bias corrected MSC may be reduced to zero by using a frequency-by-frequency logical operator 407, since negative values may be considered invalid values for a magnitude-squared quantity.

In addition, both the PSD 402 of the input signal and the PSD 405 of the output signal may be estimated. The PSD of the output signal may be divided by the PSD of the input signal using a frequency-by-frequency division operator 406 to provide the magnitude-squared transmissibility calculation. The resulting magnitude-squared transmissibility may be adjusted in order to decrease bias using a multiplicative bias correction 408, which may be a function of both the estimated MSC and the number of data points included in the average. This multiplicative bias correction may be multiplied by the PSD ratio by means of a frequency-by-frequency multiplication operator 409. Finally, the bias-corrected MSC may be multiplied by the bias-corrected magnitude-squared transmissibility utilizing a frequency-by-frequency multiplication operator 410, resulting in the improved H₁ MSFRF 411.

In conjunction with the improved H₁ MSFRF, an illustrative embodiment may utilize a weighting function 106 configured as a linear transition to 1) apply zero weight to the MSFRF until a first predefined number of degrees of freedom has elapsed, in order to ensure that the MSFRF meets a desired initial accuracy; 2) apply a first linear transition until a second predefined number of degrees of freedom has elapsed, which transition smoothly increases the weight placed on the MSFRF as that estimator becomes more accurate; 3) apply a second linear transition until a third predefined number of degrees of freedom has elapsed, which transition smoothly decreases the weight placed upon the MSFRF as the standard PSD becomes more accurate; and 4) once the desired degrees of freedom has been achieved, again apply zero weight to the MSFRF such that the PSD estimate is equal to the standard PSD Estimator.

In an illustrative embodiment the number of Degrees of Freedom used in the averaging may be set to N. In this example, let

$$= \frac{1}{N} {\sum }_{i = 1}^{N} {X}_{i} \cdot {X}_{i}^{H}$$

equal the input-signal's PSD estimation in the i^{th} frequency bin utilizing Welch's method or other suitable technique for estimating the power of a signal at different frequencies (i.e., spectral density estimation). Welch's method processing may be based on the concept of using periodogram spectrum estimates, which are the result of converting a signal from the time domain to the frequency domain. Welch's method advantageously performs periodogram spectrum estimating in that it reduces noise in the estimated power spectra in exchange for reducing the frequency resolution. Due to the noise caused by imperfect and finite data, the noise reduction from Welch's method may be desired.

Allowing

$$= \frac{1}{N} {\sum }_{i = 1}^{N} {Z}_{i} \cdot {Z}_{i}^{H}$$

equal the output-signal's PSD estimation in the i^{th} frequency bin (via Welch's method), and allowing

$$= \frac{1}{N} {\sum }_{i = 1}^{N} {X}_{i} \cdot {Z}_{i}^{H}$$

equal the cross spectral density estimation between the input and output in the i^{th} frequency bin (via Welch's method), a transmissibility-based estimation may be expressed as:

$$= \frac{}{} , and + + \cdot ( {σ}^{2} - ) = \cdot {σ}^{2} = \frac{{σ}^{2} \cdot }{} .$$

Where H₁ based estimation may be expressed as

$$= \frac{}{} , and = + {\vert \vert}^{2} \cdot ( {σ}^{2} - ) .$$

H₂ based estimation may be expressed as

$$= \frac{{H}^{}}{} , and = + {\vert \vert}^{2} \cdot ( {σ}^{2} - ) .$$

A standard coherence estimator may be provided by:

$$= \frac{\cdot {H}^{}}{\cdot }$$

It should be noted here that the following equivalency should hold, in relation to the H₁, coherence, and transmissibility estimators:

[symbol]

= [symbol] · [symbol] .

In an illustrative embodiment, bias correction on the coherence estimator may be determined from

$$= + \frac{{k}_{1}}{N} ( 1 - ) ( - {k}_{2} )$$

$${k}_{1} = 2.34$$

$${k}_{2} = 0.48$$

Bounding the result [symbol] between [0,1], a bias corrected transmissibility estimator may be determined from:

$$= ( \frac{N - 2 }{N - 2} ) \cdot$$

Accordingly, a bias corrected H₁ estimator may be determined from

[symbol]

= [symbol] ·

[symbol]

Where a preferred estimator, using a bias-corrected H₁ estimator, may be determined from:

[symbol]

= [symbol] + [symbol] ·(σ²− [symbol] )

A bias-corrected H₁ estimator may be advantageous in that a H₁ based estimator results in biased PSD estimates, with the bias being a function of the amount of averaging (Degrees of Freedom) and the coherence between the output and the source. Ideally, the estimator should reduce bias according to coherence while maintaining the same expected value of the output power as when that power is estimated using FFT averaging techniques (e.g., Welch's method). This may be expressed as E[ [symbol] ]=E[ [symbol] ].

An important factor in the H₁ based estimator is [symbol] ² which equals

$$\cdot \frac{}{} .$$

There is bias in the mean-square-coherence (MSC) estimator ( [symbol] ) and in the transmissibility ratio

itself. Accordingly, there may be bias in the [symbol] ² estimator as well. This may produce a need to reduce bias in both components, in order produce an overall bias reduction in the improved estimator. As such, an expected value (e.g., the first moment) of the ratio of correlated chi-square variables, i.e., the expected value of the ratio

$$\frac{}{}$$

may be determined from:

$$E ( \frac{{U}_{1}}{{U}_{2}} ) = \frac{m - 2 {ρ}^{2}}{m - 2} , m > 2$$

where U₁, U₂ are random variables having a correlated bivariate chi-square distribution, each with m degrees of freedom, and where −1<ρ<1 is the product moment correlation coefficient.

Furthermore, it can be appreciated by those skilled in that art that during any random test, knowledge of the true value of the correlation coefficient is unknown, and [symbol] should be substituted for ρ². In certain cases there is a bias in the mean-square-coherence (MSC) estimator ( [symbol] ) and in the transmissibility ratio

$$\frac{}{}$$

itself, and so it follows that there is bias in the [symbol] ² estimator as well. Thus may produce a need to reduce bias in both components, in order produce an overall bias reduction in the improved estimator. As such, an expected value (e.g., the first moment) of the ratio of correlated chi-square variables, i.e., the expected value of the ratio

$$\frac{}{} ,$$

may be determined from

$$E ( \frac{{U}_{1}}{{U}_{2}} ) = \frac{m - 2 {ρ}^{2}}{m - 2} , m > 2$$

where U₁, U₂ are random variables having a correlated bivariate chi-square distribution as defined in the article, each with m degrees of freedom, and where −1<ρ<1 is the product moment correlation coefficient.

In addition, the MSC estimator may include bias, where a bias approximation may be determined from

$${B}_{1} ( C , N ) = \frac{1}{N} {( 1 - C )}^{2} ( 1 + \frac{2 C}{N} ) ,$$

where C represents true coherence-squared and N represents the number of non-overlapping segments averaged together. As can be appreciated by those skilled in the art, the approximation of the bias amount is dependent on the number of segments averaged (i.e., the Degrees of Freedom) as well as the true coherence-squared, the exact value of which is normally unknown during a random test. By reformulating the approximation, and substituting the estimator itself for the true value, a bias approximation may be determined from

$$\hat{\hat{C}} = max [ 0 , \hat{C} - \frac{1}{N} {( 1 - \hat{C} )}^{2} ( 1 + \frac{2 \hat{C}}{N} ) ] ,$$

where C is replaced with the coherence-squared estimate, Ĉ, the bias approximation is subtracted from the estimation, and negative values for coherence-squared are rejected. When dealing with power, a negative coherence-squared value would indicate that positive power is correlated with negative power, which would indicate error, since power is a squared, nonnegative quantity. For this reason, negative values of (γ_î2)^{̂} are also rejected. Of course, by using an estimation for coherence-squared in place of a true value, some bias may still be present. However, this bias is still reduced when compared to the normal MSC estimation, Ĉ.

Accordingly, a bias-corrected coherence estimate may be determined by substituting (Ĉ= [symbol] ), where

$$= max [ 0 , - \frac{1}{N} {( 1 - )}^{2} ( 1 + \frac{N}{} ) ]$$

Then, using this bias-corrected coherence estimate together with the bias-corrected transmissibility estimate, a bias-corrected H₁ estimator utilizing the outputs and inputs (see FIG. 1) may be determined from

$$= + ( \frac{N -}{N - 2} ) \cdot ( \frac{{σ}^{2} \cdot }{} ) \cdot \cdot ( {σ}^{2} - ) .$$

It should be understood by those skilled in the art that the configurations described herein provide a quick, accurate and flexible system for PSD estimation and vibration test processing. As a practical matter, when running a random vibration test, a part of the test relates to measuring the vibration waveform, and to estimate the Power PSD of that waveform so that it may be compared to the desired PSD level prescribed by a test specification. The conventional systems and methods of estimating the PSD requires greater amounts of information to improve accuracy. For vibration testing, the information is often related to estimating Degrees of Freedom (DOF), where, as the DOF setting of the controller becomes higher, the traces will appear smoother on the graphs. With a higher DOF there is more data gathered and included in the average, and therefore the estimate of the PSD improves. As the estimate improves, it will get closer to the true PSD of the waveform, the variations in the estimate get smaller, and a smoother appearance to the graph trace will result. However, the amount of time and processor overhead required for high-accuracy PSD estimates is often prohibitive, and users often must sacrifice at least one of accuracy and speed in order to obtain measurements.

The present disclosure takes advantage of an overlooked piece of information, and uses that information to improve the quality of the PSD estimate. The traditional method of estimating the PSD assumes that the only information available is in the raw measurements. However, in a random vibration test the signal being measured is a result of a signal generated by the controller. By redesigning the controller, this signal can be derived from a noise source with known statistical properties. This additional information (i.e., the statistical properties of the noise source) may be used to determine the estimation error, which may be expressed as the difference between values computed by the PSD estimation method being used, and the true underlying PSD. Once this difference is known, it can then be used to remove the estimation error from other PSD estimates made using the same algorithm on correlated signals, resulting in quicker PSD estimates that are more accurate than can be provided by a traditional PSD estimator.

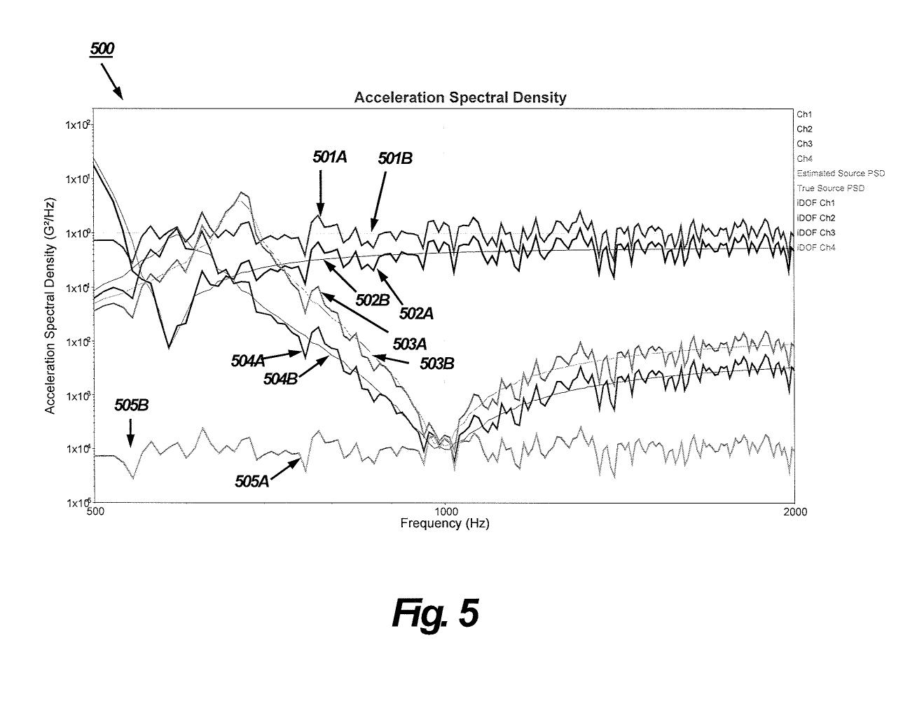

FIG. 5 shows simulated waveforms 500 of PSD traces under illustrative embodiments, where it can be seen how conventional PSD estimator traces (501A-504A) compare with the PSD estimator traces produced under the present disclosure (501B-504B using an identical data set, except that the PSD estimate (501B-504B) under the present disclosure utilize the addition of a known PSD of the noise source (e.g., 101). It may be appreciated by those skilled in the art that differences between the ‘Estimated Source PSD’ and ‘True Source PSD’ is highly correlated with the jaggedness of the Ch1 through Ch4 lines (501A-504A). Since the ‘True Source PSD’ is a known quantity, and the ‘Estimated Source PSD’ may be calculated from the data set, the estimation error present in the ‘Estimated Source PSD’ trace may be directly computed. Since this estimation error is highly correlated with the estimation error present in the Ch1 through Ch4 traces, this estimation error may be transferred from the Source to the Ch1 through Ch4 traces, and the jaggedness from those traces may be subtracted. The result may provide a much better estimate of the true PSD of those signals, and much smoother curves, without requiring the large quantity of data which would otherwise be required to achieve this amount of accuracy.

The techniques described herein may be thought of as providing “instant degrees of freedom” by utilizing technologies for PSD estimation designed to rapidly reduce the estimation error at the beginning of a test and after changes in the test level occur. In doing so, the PSD estimate disclosed herein approaches an expected value of the signal's PSD quickly, allowing for rapid verification of tolerance limits and/or faster detection of and reaction to an abort condition. The present disclosure accomplishes this significantly faster than traditional averaging techniques. Also, unlike other methods that attempt to rapidly display a clean PSD, the presently disclose techniques produces a PSD estimate that accurately depicts a full level signal PSD, without clouding the estimate with readings made at other test levels.

When addressing errors in a PSD plot (e.g., the difference between the control and demand curves), there may be two sources of error: control error and estimation error. Control error refers to the discrepancy between the actual PSD of the data (signal) and the desired demand PSD. Estimation error refers to the discrepancy between the plotted PSD and the actual PSD. For instance, if the PSD estimation's averaging is reset during a test (without changing level), this would not affect the signal, and thus the actual PSD of the data wouldn't change. However, the immediate effect on the PSD display would result in a very jagged representation until enough new data has been accumulated to average out and accurately estimate the PSD. The error evident in this jaggedness would be attributable to estimation error. This would be one example where, although the data plotted on a screen has a large variance, the control may in fact be very good, with only a small amount of control error.

As another example, taking into consideration the PSD estimation method which involves the multiplication of low-level data during a change in level, the actual PSD of the signal undergoes a major change—including shifts in resonant frequencies—since the signal is substantially changing (increasing in power). Yet, the PSD estimate derived by multiplying the low-level data doesn't indicate any changes in the PSD plot at the higher level. At a higher level, although this method gives the appearance of minimal control error and minimal estimation error on the plot, there is in reality a significant difference between the actual PSD of the signal and the estimated PSD shown on the plot. In this case, there is both large control error and large estimation error, and the estimation error offsets and masks the presence of control error.

Control error may significantly affect the signal and arises from resonances in the signal or other noise added by the system to the signal that makes the controller work to accommodate. It is the control error that test systems are typically focused on detecting. Estimation error may mask the presence of control error, and the estimation error may be introduced when estimating the PSD of a random signal. This estimation error may be the 1/F PSD variance described above. Thus, even if the signal was perfect, and there was no control error, there would still be estimation error present in the PSD display, where estimation error would decrease inversely proportionally with degrees of freedom. Further, the presence of estimation error does not imply the presence of control error, since estimation error should not concern the control of the signal.

The present disclosure provides techniques to remove, at least in part, estimation error while preserving control error. In other words, the embodiment of FIG. 1 (along with the embodiments of FIGS. 2-4) will reduce or remove estimation error, enabling the user to see control error more clearly. The present disclosure provides a test system, in a short amount of time, a precise view of the signal's actual PSD, along with a cleaner, uncluttered representation of the true vibration. It should be also appreciated by those skilled in the art that the techniques described herein are not limited strictly to vibration testing of devices, but may be applied in a variety of applications including, but not limited to, acoustic signal processing and power signal processing.

In the foregoing detailed description, it can be seen that various features are grouped together in individual embodiments for the purpose of brevity in the disclosure. This method of disclosure is not to be interpreted as reflecting an intention that the subsequently claimed embodiments require more features than are expressly recited in each claim.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather are to be accorded the widest scope consistent with the principles and novel features disclosed herein.

What is claimed is:

1. A system for estimating power spectral density (PSD), comprising:
a processing apparatus, comprising a random signal generator for producing a source signal comprising known statistical properties, and a first converter configured to convert the source signal to a power spectral density (PSD) representation; and
a test system, operatively coupled to the processing apparatus, the test system configured to receive the source signal and produce an output signal,
wherein the processing apparatus further comprises
a second converter configured to convert the output signal to a second PSD representation,
an estimator configured to estimate a magnitude-squared frequency response function (MSFRF) of output signal and source signal,
a weighting module, configured to weight an estimation error factor based on at least one of a quality of the estimate and a user preference, and
a removal module, to remove a portion of the estimation error from the output signal PSD.

2. The system for estimating PSD as in claim 1, wherein the estimator comprises a magnitude-square of a transmissibility calculation.

3. The system for estimating PSD as in claim 1, wherein the estimator consists of a magnitude-square of an H₁ transfer function calculation.

4. The system for estimating PSD as in claim 1, wherein the estimator consists of a magnitude-square of an H₂ transfer function calculation.

5. The system for estimating PSD as in claim 1, wherein the estimator consists of a magnitude-square of an Hₛ transfer function calculation.

6. The system for estimating PSD as in claim 1, wherein the estimator consists of a magnitude-square of an Hᵥ transfer function calculation.

7. A processor-based method for estimating the magnitude-square frequency response function, comprising:
estimating, via a first estimator, a magnitude-squared coherence estimate;
compensating, via a first bias correction, the magnitude-squared coherence estimate for bias;
limiting, via a limiter, the bias-corrected magnitude-squared coherence (MSC) estimate to values, between 0 and 1;
estimating, via a second estimator, a magnitude-squared transmissibility function;
compensating, via a second bias correction, the magnitude-squared transmissibility function for bias; and
multiplying, via a multiplication operator, the bias-corrected MSC estimate with the bias-corrected magnitude-squared transmissibility calculation, for providing an improved H₁ MSFRF.
